(19) United States
(12) Patent Application Publication
(10) Pub. No.: US 2014/0260765 A1
(43) Pub. Date: Sep. 18, 2014

(54) PUSH/PULL CABLE

(71) Applicant: Marine Acquisition (US) Incorporated, Limerick, PA (US)

(72) Inventors: Jeffery Paul Granda, Easton, PA (US); Matthew K.C. Green, Macungie, PA (US); Dennis Graham, Reading, PA (US)

(21) Appl. No.: 14/351,246

(22) PCT Filed: Oct. 15, 2012
(86) PCT No.: PCT/US12/60185

§ 371 Date: Apr. 11, 2014

Related U.S. Application Data
(60) Provisional application No. 61/547,345, filed on Oct. 14, 2011.

(51) Int. Cl. F16C 1/26

(52) U.S. Cl. CPC F16C 1/26
USPC 74/502.5

(57) ABSTRACT

A push/pull cable comprises a cable core and a cable core liner. The cable core includes a central mandrel wire and an outer helical wire wound about the central mandrel wire. The cable core liner has a splined inner wall and the cable core is disposed within the cable core liner.

### CROSS-REFERENCE TO RELATED APPLICATION

This Application claims the benefit under 35 U.S.C. 119(e) of U.S. Provisional Application Ser. No. 61/547,345 filed Oct. 14, 2011 by Granda et al., which is hereby incorporated herein by reference in its entirety and to which priority is claimed.

### BACKGROUND OF THE INVENTION

1. Field of the Invention

The present invention relates to a push/pull cable and, in particular, to a push/pull cable having a cable core liner with a splined or grooved inner surface.

2. Description of the Related Art

U.S. Pat. No. 3,240,233 issued on Mar. 15, 1966 to Johnston discloses a round wire within a guiding conduit having a ribbed or lobed aperture for guiding the wire.

U.S. Pat. No. 4,112,708 issued on Sep. 12, 1978 discloses a flexible drive cable comprising a shaft or elongate torque-transmitting core member movably disposed within an internal passage of an elongate tubular liner member made of plastic. An elongate tubular outer member holds therein the elongate tubular liner member. The elongate tubular outer member comprises reinforcing wires and a plastic material which is integral with the reinforcing wires.

### SUMMARY OF THE INVENTION

It is an object of the present invention to provide an improved push/pull cable.

There is accordingly provided a push/pull cable comprising a cable core and a cable core liner. The cable core liner has a splined inner wall and the cable core is disposed within the cable core liner. The cable core may include a central mandrel wire and an outer helical wire wound about the central mandrel wire. The push/pull cable may further include a plurality of lay wires surrounding the cable core liner and a coating covering the plurality of lay wires.

The splined inner wall of the cable core liner may include two opposed splines with each of the splines having a respective land. A width of each respective land may be equal to a distance between the opposed splines*π/50. A width of each of the splines may be between 200% and 300% times the width of its respective land. An inner diameter of the cable core liner may be between 102.5% and 107.5% times a distance between the opposed splines. An outer diameter of the cable core liner may be between 122% and 128% times the distance between the opposed splines. The distance between the opposed splines may be a distance between the lands of the opposed splines.

### BRIEF DESCRIPTIONS OF DRAWINGS

The invention will be more readily understood from the following description of the embodiments thereof given, by way of example only, with reference to the accompanying drawings, in which:

FIG. 1 is a broken-away, isometric view of an improved push/pull cable;

FIG. 2 is a broken-away, isometric view of a cable conduit of the push/pull cable of FIG. 1;

FIG. 3 is a cross-sectional view taken along line 3-3 of FIG. 1;

FIG. 4 is an end view of a cable core liner of the push/pull cable of FIG. 1;

FIG. 5 is an enlarged, fragmentary end view of a portion of the cable core liner of FIG. 4;

FIG. 6 is a cross-sectional view taken along line 6-6 of FIG. 4;

FIG. 7 is an enlarged end view of a cable core liner of the push/pull cable of FIG. 1;

FIG. 8 is an end view of another embodiment of a cable core liner which may form a part of the push/pull cable of FIG. 1;

FIG. 9 is an enlarged, fragmentary end view of a portion of the cable core liner of FIG. 8;

FIG. 10 is an end view of yet another embodiment of a cable core liner which may form a part of the push/pull cable of FIG. 1;

FIG. 11 is a side perspective view of the cable core liner of FIG. 10;

FIG. 12 is an end view of still yet another embodiment of a cable core liner which may form a part of the push/pull cable of FIG. 1;

FIG. 13 is a side perspective view of the cable core liner of FIG. 12;

FIG. 14 is an end view of yet still another embodiment of a cable core liner which may form a part of the push/pull cable of FIG. 1;

FIG. 15 is a side perspective view of the cable core liner of FIG. 10;

### DESCRIPTIONS OF THE PREFERRED EMBODIMENTS

Referring to the drawings and first to FIG. 1, an improved push/pull cable 10 is shown. The push/pull cable 10 comprises a cable core 12 which, in this example, includes a central mandrel wire 14 and an outer helical wire 16 wound about the central mandrel wire. The cable core 12 is disposed within a cable core liner 18 which, in this example, is a plastic liner formed from high density polyethylene. A plurality of lay wires, for example lay wires 20a, 20b and 20c, surround the cable core liner 18 and provide resistance to axial compression loads. A plastic coating 22 covers the lay wires 20a, 20b and 20c. Together the plastic coating 22, lay wires 20a, 20b and 20c, and cable core liner 18 constitute a cable conduit 11 which is shown in FIG. 2.

An inner wall 24 of the cable core liner 18 is splined. This is better shown in FIG. 3. There is a plurality of spaced apart splines, for example splines 26a, 26b and 26c, extending longitudinally along the inner wall 24 of the cable core liner 18. The cable core 12 only contacts the cable core liner 18 at the splines. This reduces the area of frictional contact between the cable core 12 and the cable core liner 18. The area of frictional contact between the cable core 12 and the cable core liner 18 is further reduced by virtue of the peripheral surface area of the cable core 12 being minimized due to the outer helical wire 16 being wound about the central mandrel wire 14. Only the outer helical wire 16 contacts the splines. In FIG. 3 the outer helical wire 16 of the cable core 12 is only in contact with two of the splines 26a and 26b on the plane of line 3-3, which is shown in FIG. 1. It will be understood by a person skilled in the art that increasing the pitch of the outer helical wire 16 will decrease the peripheral surface area of the cable core 12 which contacts the cable core liner 18, and decreasing the pitch of outer helical wire 16 will increase the peripheral surface area of the cable core 12 which contacts the cable core liner 18.

Referring back to FIG. 3, there are longitudinally extending channels, for example channels 28a, 28b and 28c, interposed between the splines. Lubricant may be conveyed along the push/pull cable 10 through the channels. Although the inner wall 24 of the cable core liner 18 is described as splined herein, it will be understood by a person skilled in the art that the inner wall 24 of the cable core liner 18 may alternatively be described as grooved with the channels 28a, 28b and 28c being grooves.

The cable core liner 18 is best shown in FIGS. 4 to 7. Referring specifically to FIG. 4, this embodiment of the cable core liner 18 has ten longitudinally extending splines although other embodiments may have different numbers of spline, for example, between 6 and 20 splines. The splines are substantially similar in structure and function. Accordingly only one of the splines 26c, which is best shown in FIG. 5, will be described in detail herein with the understanding that the other splines have a substantially similar structure and function in a substantially similar manner. The spline 26c is symmetrical and has a land 30 with opposite planar side walls 32 and 34 extending angularly from the land 30 to the inner wall 24 of the cable core liner 18. As shown for one of the angular walls 32, an angle θ between a line of symmetry L of the spline 26c and a slope S of each of the side walls 32 and 34 is between 60° or 68°. In this embodiment the angle θ is 63° or 64°. The slope S of the planar side walls 32 and 34 results in the width W₁ of the land 30, shown in FIG. 7, being less than the width W₂ of the spline 26c. The width W₂ of the spline 26c may be between 200% and 300% of the width W₁ of the land 30. In this example, the W₂ of the spline 26c is 250% of the width W₁ of the land 30. In this example, the width W₁ of the land 30 is determined by the core clearance or distance D₁ between lands 30d and 30e of opposed splines 26d and 26e using the formula W₁=D₁*π/50.

The core clearance or distance between opposed lands or distance D₁ is also used to determine the inner diameter D₂ and outer diameter D₃ of the cable core liner 18. The inner diameter D₂ of the cable core liner 18 is between 102.5% and 107.5% of D₁ and, in this embodiment, 105% times D₁. The outer diameter D₃ of the cable core liner 18 is between 122% and 128% times D₁ and, in this embodiment, 125% of D₁. The above described geometry of the cable core liner 18 has been found to support the drawing down of the lay wires 20a, 20b and 20c (shown in FIGS. 1 and 2) to prevent the collapse of the cable core liner 18 at thinner wall regions between the splines.

The cable core liner 18 also maintains an appropriate cable ease-of-operation, which is the force required to move the core of a cable inside the cable conduit 11. In order to maintain an appropriate cable ease-of-operation D₁ of the cable core liner 18 must be made with a diameter greater than an outer diameter of the cable core 12. As the difference between the outer diameter of the cable core 12 and D₁ of the cable conduit liner 18 (clearance) decreases, the ease-of-operation increases due to fluctuation of cable core 18 or cable conduit 11 straightness and diameter and subsequent interference with each other. Conversely, as the clearance between the cable core 12 and D₁ of the cable conduit liner 18 (clearance) increases, the ease-of-operation decreases. However, the cable backlash, which is a measurement of the core-to-conduit clearance measured over the length of the cable, also increases. This extra cable backlash could become excessive and lead to a condition where an input end of a push/pull cable 10 is moved and there is a significant delay until the output end of the push/pull cable 10 moves. The splined cable core liner 18 and pitch of the outer helical wire 16 function to decrease the contact area between the cable core 12 and cable conduit 11. This decrease in contact area allows the conduit liner inner diameter to be decreased without affecting the ease-of-operation of the push/pull cable 10. The decrease in the inner diameter D₁ of the cable conduit liner 18 also decreases the clearance between the cable core 12 and cable conduit 11 and leads to lower cable backlash.

Referring now to FIGS. 8 and 9 another embodiment of a cable core liner 40 is shown. The cable core liner 40 shown in FIGS. 8 and 9 is generally similar to the cable core liner 18 shown in FIGS. 1 to 7 with the notable exception that each spline 42 thereof is provided with a land 44 which is concavely curved and opposite side walls 46 and 48 which curve concavely from the land 42 to an inner wall 49 of the cable core liner.

Referring now to FIGS. 10 and 11 yet another embodiment of a cable core liner 50 is shown. The cable core liner 50 shown in FIGS. 10 and 11 is generally similar to the cable core liner shown in FIGS. 8 and 9 but is provided with eight splines.

Referring now to FIGS. 12 and 13 still yet another embodiment of a cable core liner 60 is shown. The cable core liner 60 shown in FIGS. 12 and 13 is generally similar to the cable core liner shown in FIGS. 8 and 9 but is provided with fourteen splines.

Referring now to FIGS. 14 and 15 yet still another embodiment of a cable core liner 70 is shown. The cable core liner 70 shown in FIGS. 14 and 15 is generally similar to the cable core liner shown in FIGS. 8 and 9 but is provided with twenty splines.

The geometry of the cable core liners of FIGS. 8 to 15 is governed by the same principles as described for the cable core liner of FIGS. 4 to 7 with the notable exception that width of the splines W₂ is the distance between theoretical sharp points.

The push/pull cable disclosed herein may be used as a mechanical control cable in a steering system for controlling speed, direction of motion, braking, and engine operation in marine vessels and/or land vessels.

It will be understood by a person skilled in the art that many of the details provided above are by way of example only, and are not intended to limit the scope of the invention which is to be determined with reference to the following claims.

1. A push/pull cable comprising:
a cable core including a central mandrel wire and an outer helical wire wound about the central mandrel wire; and
a cable core liner, the cable core liner having a splined inner wall and the cable core being disposed within the cable core liner.

2. The push/pull cable as claimed in claim 1 further including a plurality of lay wires surrounding the cable core liner and a coating covering the plurality of lay wires.

3. The push/pull cable as claimed in claim 1 wherein the splined inner wall of the cable core liner includes two opposed splines with each of the splines having a respective land, and wherein a width of each respective land is equal to a distance between the opposed splines*π/50.

4. The push/pull cable as claimed in claim 1 wherein the splined inner wall of the cable core liner includes two opposed splines with each of the splines having a respective land, and wherein a width of each of the splines is between 200% and 300% times a width of its respective land.

5. The push/pull cable as claimed in claim 1 wherein the splined inner wall of the cable core liner includes two opposed splines, and wherein an inner diameter of the cable core liner is between 102.5% and 107.5% times a distance between the opposed splines.

6. The push/pull cable as claimed in claim 5 wherein the opposed splines each have a respective land and the distance between the opposed splines is a distance between said lands.

7. The push/pull cable as claimed in claim 1 wherein the splined inner wall of the cable core includes two opposed splines, and wherein an outer diameter of the cable core liner is between 122% and 128% times a distance between the opposed splines.

8. The push/pull cable as claimed in claim 7 wherein the opposed splines each have a respective land and the distance between the opposed splines is a distance between said lands.

9. The push/pull cable as claimed in claim 1 wherein the outer helical wire has a pitch which functions to decrease contact area between the cable core and the cable core liner.

10. A push/pull cable comprising:
a cable core including a central mandrel wire and an outer helical wire wound about the central mandrel wire; and
a cable core liner, the cable core liner having a splined inner wall with two opposed splines and each of the splines having a respective land, a width of each respective land being equal to a distance between the opposed splines*π/50 and a width of each of the splines is between 200% and 300% times a width of its respective land, the cable core being disposed within the cable core liner.

11. A push/pull cable comprising:
a cable core including a central mandrel wire and an outer helical wire wound about the central mandrel wire; and
a cable core liner, the cable core liner having a splined inner wall with two opposed splines and each of the splines having a respective land, wherein an inner diameter of the cable core liner is between 102.5% and 107.5% times a distance between the respective lands of the opposed splines and an outer diameter of the cable core liner is between 122% and 128% times a distance between the respective lands to of the opposed splines, the cable core being disposed within the cable core liner.
